(19) United States
(12) Patent Application Publication
(10) Pub. No.: US 2005/0086512 A1
(43) Pub. Date: Apr. 21, 2005

(54) Worm blocking system and method using hardware-based pattern matching

(75) Inventors: Sang-Woo Lee, Incheon (KR); Yeon-Sik Ryu, Gyeonggi-do (KR); Seung-Jong Pyo, Seoul (KR)

Correspondence Address: BIRCH STEWART KOLASCH & BIRCH, PO BOX 747, FALLS CHURCH, VA, 22040-0747, US

(73) Assignee: LG N-Sys Inc., Seoul City (KR)

(21) Appl. No.: 10/932,063

(22) Filed: Sep. 2, 2004

(30) Foreign Application Priority Data
Sep. 3, 2003 (KR) 2003-61541

(51) Int. Cl. H04L 9/00

(52) U.S. Cl. 713/200

(57) ABSTRACT

The present invention relates generally to a worm blocking system including a dedicated hardware-based board for performing pattern matching without a change in an existing network environment, which is installed in front of a network to be protected, inspects whether worm-related patterns exist on all packets on communication lines without loss or delay, passes packets through the system or blocks packets according to corresponding security rules and informs an administrator of results in real time, and a worm blocking method. In particular, the present invention relates to a hardware-based system and method for detecting and blocking worm-related packets which is suitable for a gigabit environment.

### BACKGROUND OF THE INVENTION

1. Field of the Invention

The present invention relates generally to a worm blocking system including a dedicated hardware-based board for performing pattern matching without a change in an existing network environment, which is installed in front of a network to be protected, inspects whether worm-related patterns exist on all packets on communication lines without loss or delay, passes packets through the system or blocks packets according to corresponding security rules and informs an administrator of results in real time, and a worm blocking method. In particular, the present invention relates to a hardware-based system and method for detecting and blocking worm-related packets, which is suitable for a gigabit environment.

2. Description of the Related Art

Worms are program pieces that move between programs in a single computer system or automatically spread to other computers through a network. Unlike viruses, worms do not have specific infection objects and do not include code that directly destruct computer systems or causes the incorrect operations of the computer systems. However, since the worms impose excessive loads on the computer systems and the network while spreading, the worms may cause computer systems or networks downtime. In particular, while the worms do not have specific infection objects, the worms spread based on random information obtained from infected objects so that the worms are characterized in that it is almost impossible to control or manage the worms using any conventional methods after the worms are released from sources to the network.

Computer viruses are malicious programs that infiltrate into computers, and damage data or cause other programs become inoperable. The computer viruses are characterized in that they have infection objects, infect current infection objects and reproduce themselves to infect other infection objects.

Worm viruses are viruses into which the above-described worms and computer viruses are combined, and are characterized in that the computer viruses rapidly spread using the worms. In practice, the spreading speed of the worm viruses is so fast and destructive that worm viruses, which were initially reported in a foreign country, spread into Korea in only several hours and infect tens of thousands of computers less than one day after the worm viruses begin to spread into Korea. Recently, hacking tools, such as Back Doors, and spyware functions, such as Trojans, are added to the worm viruses in addition to the basic functions of worms and computer viruses. The function and destructive power of the worm viruses are being enhanced, the spreading speed of the worm viruses is increasing, and the cash value of the damage they cause is increasing enormously.

Accordingly, various methods of blocking worms or worm viruses have been used.

Generally, to block worms, vaccine programs are installed on individual hosts, or software-based virus blocking systems are installed to prevent worms from infiltrating into computer networks in advance. Furthermore, in the case of an L7 application switch, worm attacks can be blocked using content filtering.

In the past, in the case of installing vaccine programs on hosts, functions of detecting whether data and files which will be transmitted to the hosts, are infected by worms and curing are performed. In the case of a gateway-level virus blocking system, functions of detecting whether data and files have been infected and curing are performed on all traffics to fundamentally prevent viruses or malicious information from entering into or exiting from a gateway that is a start point of a network. In the case of an L7 application switch, pattern matching related to worm attacks is performed on the data parts of passing packets on an application level, and the L7 application switch can protect against worm attacks by blocking attack packets if the packets are determined to be the attack packets. In the case where the worm attacks are blocked by installing host-based vaccine programs, there arises a problem in that an administrator encounters management difficulties as the size of a network increases. In the case where the worm attacks are blocked by installing a gateway-level virus blocking system, loads imposed on the virus blocking system increase as traffic increases because the blocking system is implemented based on software, thus causing problems of a reduction in speed, etc. Similarly, in the case where the worm attacks are blocked using the L7 application switch, there are problems in that performance can be lowered and the system may be stopped at the time of performing the content filtering.

### SUMMARY OF THE INVENTION

Accordingly, the present invention has been made keeping in mind the above problems occurring in the prior art, and an object of the present invention is to provide a worm blocking system including a dedicated hardware-based board for performing pattern matching without a change in an existing network environment, which is installed in front of a network to be protected, inspects whether worm-related patterns exist on all packets on communication lines without loss or delay, passes packets through the system or blocks packets according to corresponding security rules and informs an administrator of results in real time, and a worm blocking method. In particular, the present invention relates to a hardware-based system and method for detecting and blocking worm-related packets which is suitable for a gigabit environment.

In order to accomplish the above object, the present invention provides a worm packet detection and blocking system using hardware-based pattern matching, including a host system connected behind a gateway in a transparent mode and installed in front of the client or server of a network to be protected against worm attacks in order to block the worm attacks, and a Peripheral Component Interconnect (PCI) board mounted in the host system, adapted to perform pattern matching on received packets according to security rules received from the host system, and adapted to block a matching packet according to a corresponding security rule.

The worm packet detection and blocking system may further include a management console for transmitting the security rules to the host system, receiving a worm alert signal from the host system and displaying the worm alert signal.

The host system may be a general computer equipped with a network card. The PCI board may include a header search engine for checking the header of a packet, a content search engine for performing pattern matching, an In Line-Control (ILC) in charge of packet processing, and a security rule database for storing the security rules. The ILC may transmit an input data packet to the header search engine and the content search engine for pattern matching of a header and a content, transmit an alert signal to the host system when a worm pattern is detected as a result of the pattern matching in the header and content search engines, read a security rule corresponding to the detected worm pattern from the security rule database, and pass or block the packet according to the security rule.

In order to accomplish the above object, the present invention provides a worm packet detection and blocking method using a worm blocking system formed of a host system and a PCI board mounted on the host system, including the steps of the host system initializing the PCI board, the PCI board storing worm patterns and corresponding security rules when the host system transmits the worm patterns and the security rules to the PCI board, the PCI board searching for a worm by comparing the pattern of input data and the stored worm patterns, the PCI board transmitting an alert signal to the host system when the worm pattern is detected, and the PCI board searching the stored security rules for a security rule corresponding to the detected worm pattern and processing the worm according to the security rule.

The security rules may be transmitted to the host system from a management console connected to the worm blocking system through a network. It may be preferable that the security rules transmitted to the host system from the management console have been encrypted, and the host system decrypts the received security rules before transmitting the security rules to the PCI board.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a configuration diagram of a system according to the present invention;

FIG. 2 is a flowchart showing the log information reception and security rule transmission functions of a management console;

FIG. 3 is a flowchart showing the function of a host system;

FIG. 4a is a block diagram showing the internal construction of a PCI board;

FIG. 4b is a flowchart showing the function of the PCI board;

FIG. 5 is a format of a security rule message; and

FIG. 6 is a format of a log message transmitted to the management console from a worm blocking system.

### DESCRIPTION OF THE PREFERRED EMBODIMENTS

Reference now should be made to the drawings, in which the same reference numerals are used throughout the different drawings to designate the same or similar components.

A preferred embodiment of the present invention is described in detail with reference to the attached drawings below.

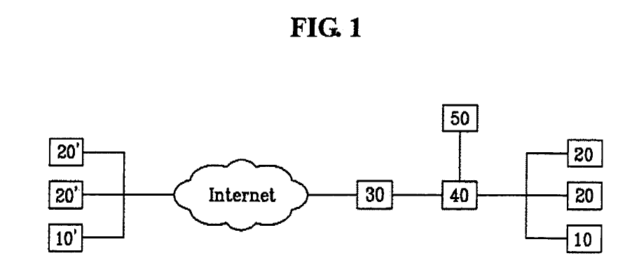

A configuration diagram showing the construction of a system for blocking worms using hardware-based pattern matching in a gigabit environment is shown in FIG. 1.

In FIG. 1, a client 10′ and servers 20′ are connected to the Internet, and a worm blocking system 40 for blocking worm attacks is located behind the gateway 30 of a network, which is to be protected, in a transparent mode without a change in an existing network environment. At this location, the worm blocking system 40 performs real-time detection and blocking of worms on all communication traffic between the host 10 of the network to be protected and the host 10′ connected to the Internet, and transmits the detection and blocking results to a management console 50. Then the management console 50 alerts an administrator that the worms have been detected by displaying the results on a screen. Furthermore the management console 50 can generate security rules to be applied to the worm blocking system 40, and apply the security rules to the worm blocking system 40 online.

The worm blocking system 40 includes a host system and a PCI format board mounted in the host system. The host system takes a general computer form, but practically functions to receive log information provided by the PCI format board and transmit the log information to the management console 50 using the PCI BUS. The PCI board for performing pattern matching is provided with a gigabit interface, so that it is possible to install the PCI board in an In-line mode without a change in a network environment. The PCI board uses the network interface of a host computer when communicating with the management console 50. The host system is connected to the management console 50 via the Internet using Transmission Control Protocol/Internet Protocol (TCP/IP), and a single management console can remotely manage a plurality of worm blocking systems.

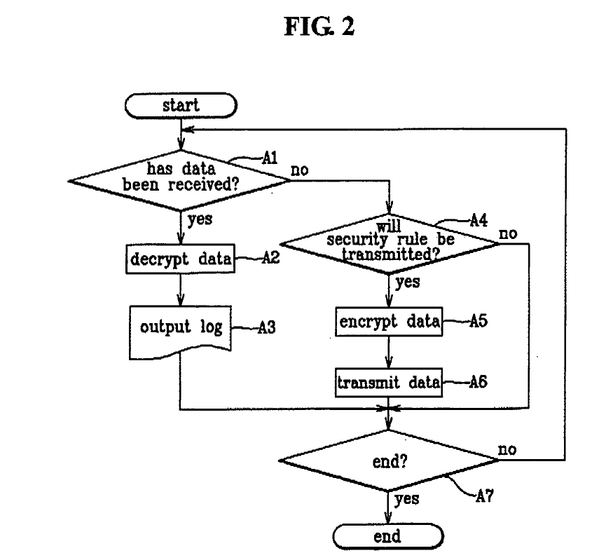

FIG. 2 is a functional flowchart showing the reception of log information and the transmission of a security rule performed by the management console 50. The management console 50 detects whether a log received from the worm blocking system 40 exists at step A1. If the received data exists, the data is decrypted using a SEED algorithm at step A2, and output to a screen and stored in a database at step A3.

If no log received from the worm blocking system 40 exists at step A1, and an administrator intends to transmit security rules including worm-related pattern and policy at step A4, the management console 50 encrypts the security rules to be transmitted at stop A5 and transmits the encrypted security rules to a corresponding worm blocking system 40 at step A6. If the process does not end at step A7, functions of steps A1 to A6 are repeated.

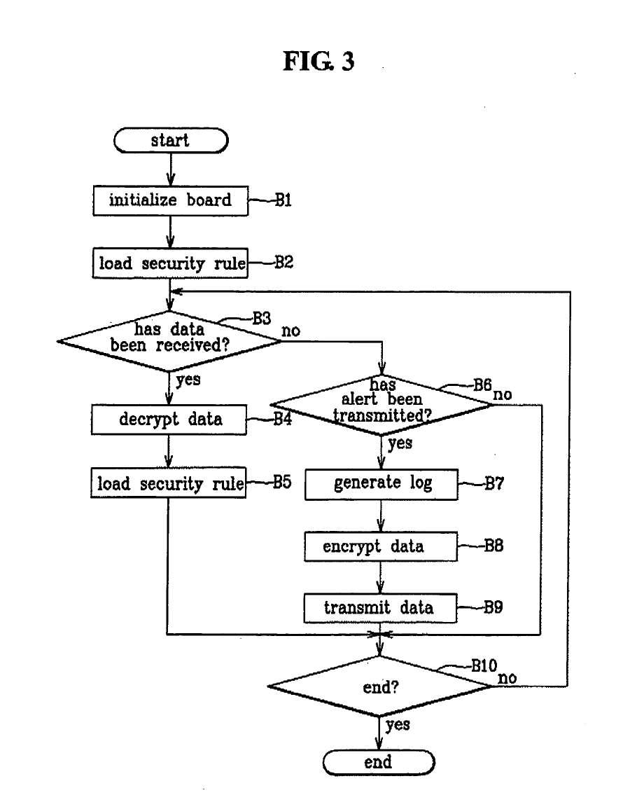

FIG. 3 is a functional flowchart of the host system. The host system performs initialization on the PCI format board that is mounted on the host system in charge of pattern matching at step B1, and reads the security rules from a file received from the management console 50 and applies the security rules to the board to detect worm attacks at step B2, furthermore, the host system inspects whether the security rules are received at step B3. If the security rules arc received, the host system decrypts the security rules using the SEED algorithm and stores the decrypted security rules in a file at step B4, and loads the file to the PCI board at step B5.

If the security rules received from the management console 50 do not exist, it is inspected whether information on the fact that a worm attack packet is detected is transmitted from the PCI board in charge of hardware-based pattern matching at step B6. If the information on the worn attack packet is received from the PCI board, the host system converts the information into a log type to be used in the management console 50 at step B7 encrypts the information using the SEED algorithm at step B8, and transmits the encrypted information to the management console 50 at step B9. The steps are repeated until the operation of the host system ends at step B10.

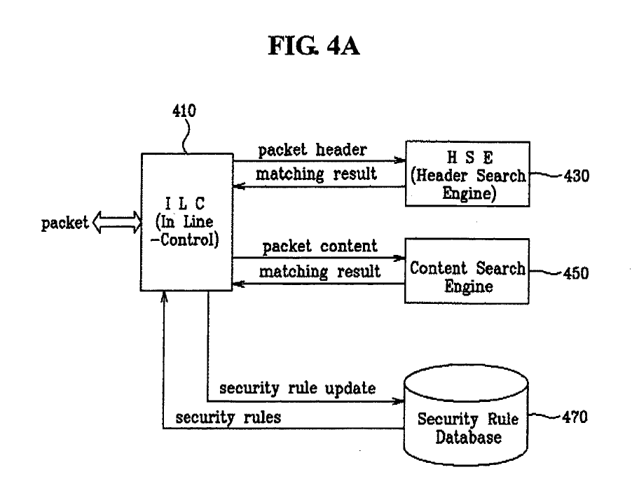

FIG. 4a is a block diagram showing the internal construction of the PCI board dedicated to pattern matching. The PCI board includes a header search engine 430 for checking the header of a packet, a content search engine 450 for performing pattern matching, an ILC 410 in charge of packet processing, and a security rule database 470.

FIG. 4b is a functional flowchart of the PCI board. When the PCI board is initialized at step B1 of FIG. 3 according to the command of the host system at step C1, the ILC 410 of the PCI board sends an input data packet to the header search engine 430 and the content search engine 450, and performs pattern matching on a header and a content at step C2. In the case where a worm pattern is detected as a result of the pattern matching in the header and content search engines at step C3, the ILC 410 transmits a log message to the host system at step C4, reads a security rule corresponding to the detected worm pattern from the security rule database 470, and passes or blocks the packet according to the security rule at step C5. Such steps are repeated until the operation of the PCI board ends at step C6.

Meanwhile, even though not shown in FIG. 4b, the ILC 410 updates the security rule database 470 using the received security rule when a load command to load security rules is received from the host system.

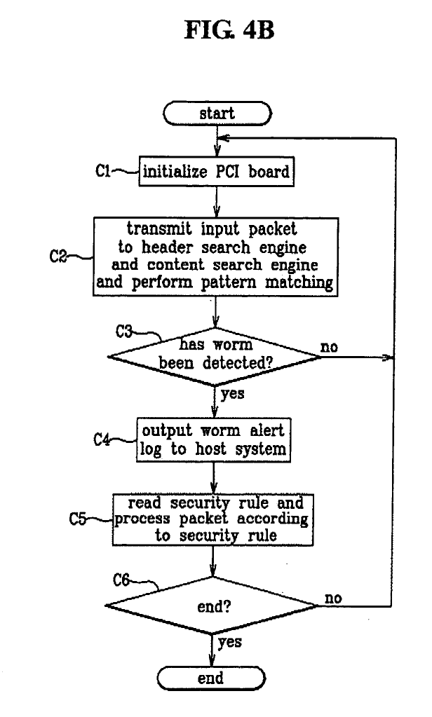

FIG. 5 is a view showing the message format of the security rule transmitted to the worm blocking system 40 from the management console 50. In this case, NUM indicates a sequential position, and the priority of detection becomes relatively higher as the sequential position is lower. Log Type is a field defining the type of a log in which alert information for a worm attack packet is transmitted from the board to the host including the board through a PCI BUS. According to Log Type, a message format in which an attack name and packet header information are transmitted, and a fill format in which an attack name and packet data are transmitted are possible. Action is a field defining the action that the board takes in the case where a corresponding worm attack packet is detected, and Action may be set to packet allowance or packet blockage. Worm Pattern is the specific pattern of a corresponding worm attack.

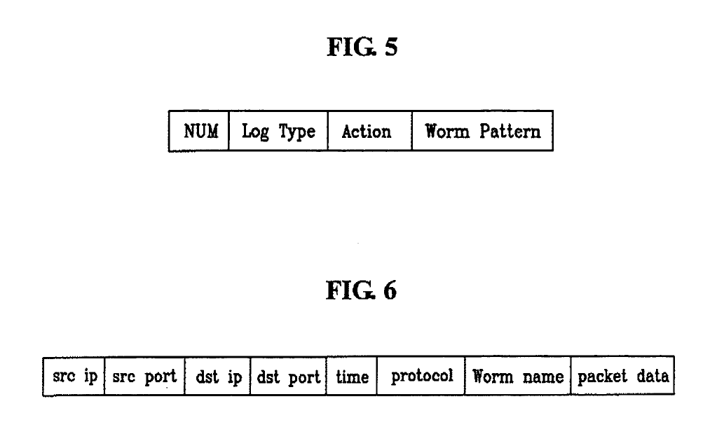

FIG. 6 is a view showing a log message format transmitted from the worm blocking system 40 to the management console 50. In this case, src ip, src port, dst ip and dst port indicate the source IP address, source port, destination IP address and the destination port of a worm attack packet, respectively, and time indicates the time when the worm attack is detected. Protocol indicates an IP upper protocol (TCP, User Datagram Protocol (UDP) or Internet Control Message Protocol (ICMP)) to which the worm attack packet belongs, worm name indicates a worm attack name, and packet data indicates the total data of a packet in the case where Log Type of the security rule is a full format.

As described above, the present invention can detect and block packets including worm attack patterns, in real time using a hardware-based PCI card without loss or delay of the packets, thus effectively protecting against worm attacks. Furthermore, the present invention can be installed without a change in an existing network, so that it is convenient to manage. Furthermore, the management console and the worm blocking system perform encryption and decryption using the SEED algorithm, so that the management console and the worm blocking system Call safely communicate with each other.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A worm packet detection and blocking method using a worm blocking system formed of a host system and a Peripheral Component Interconnect (PCI) board mounted in the host system, comprising the steps of:
the host system initializing the PCI board;
the PCI board storing worm patterns and corresponding security rules when the host system transmits the worm patterns and the security rules to the PCI board;
the PCI board searching for a worm by comparing a pattern of input data and the stored worm patterns;
the PCI board transmitting an alert signal to the host system when the worm pattern is detected; and
the PCI board searching the stored security rules for a security rule corresponding to the detected worm pattern and processing the worm according to the security rule.

2. The worm packet detection and blocking method as set forth in claim 1, further comprising the steps of:
the host system transmitting security rules to the PCI board when the security rules are transmitted to the host system from a management console connected to the worm blocking system through a network; and
the PCI board storing the security rules.

3. The worm packet detection and blocking method as set forth in claim 2, wherein:
the security rules transmitted to the host system from the management console have been encrypted; and
the host system decrypts the received security rules before transmitting the security rules to the PCI board.

4. The worm packet detection and blocking method as set forth in claim 1, wherein the host system transmits the alert signal to the management console when receiving the alert signal from the PCI board.

5. The worm packet detection and blocking method as set forth in claim 4, wherein each of the security rules includes a format of the alert signal that will be transmitted by the PCI board when the worm is detected.

6. The worm packet detection and blocking method as set forth in claim 5, wherein the format of the alert signal includes a format used when an attack name and a packet header are transmitted, and a format used when an attack name and total packet data are transmitted.

7. The worm packet detection and blocking method as set forth in claim 4, wherein the host system encrypts the alert signal before transmitting the alert signal to the management console.

8. The worm packet detection and blocking method as set forth in claim 1, wherein:
each of the security rules has a message format including NUM, Log Type, Action and Worm Pattern fields; and
the alert signal includes a source Internet Protocol (IP) address, a source port, a destination IP address, a destination port, a time, an IP upper protocol, a worm attack name and packet data.

9. A worm packet detection and blocking system using hardware-based pattern matching, comprising:
a host system connected behind a gateway in a transparent mode and installed in front of a client or server of a network to be protected against worm attacks in order to block the worm attacks; and
a PCI board mounted in the host system, adapted to perform pattern matching on received packets according to security rules received from the host system, and adapted to block a matching packet according to a corresponding security rule.

10. The worm packet detection and blocking system as set forth in claim 9, wherein the host system is a general computer equipped with a network card.

11. The worm packet detection and blocking system as set forth in claim 9, further comprising a management console for transmitting the security rules to the host system, receiving a worm alert signal from the host system and displaying the worm alert signal.

12. The worm packet detection and blocking system as set forth in claim 9, wherein the PCI board comprises:
a header search engine for checking a header of a packet;
a content search engine for performing pattern matching;
an In Line-Control (ILC) in charge of packet processing; and
a security rule database for storing the security rules.

13. The worm packet detection and blocking system as set forth in claim 12, wherein the ILC transmits an input data packet to the header search engine and the content search engine for pattern matching of a header and a content, transmits an alert signal to the host system when a worm pattern is detected as a result of the pattern matching in the header and content search engines, reads a security rule corresponding to the detected worm pattern from the security rule database, and passes or blocks the packet according to the security rule.
